(19) United States
(12) Patent Application Publication
(10) Pub. No.: US 2021/0136316 A1
(43) Pub. Date: May 6, 2021

(54) ENCLOSED SECURITY SYSTEM

(71) Applicant: Vardan Tandretsyan, Van Nuys, CA (US)

(72) Inventor: Vardan Tandretsyan, Van Nuys, CA (US)

(21) Appl. No.: 16/669,116

(22) Filed: Oct. 30, 2019

(51) Int. Cl. H04N 5/77; G08B 13/196; G08B 29/18

(52) U.S. Cl. CPC H04N 5/772; G08B 29/181; G08B 13/19619; G08B 13/19656

(57) ABSTRACT

An enclosed security system, including a system container to store at least one item therein, a connection panel removably disposed within at least a portion of an interior of the system container to receive a connection from at least one security camera, and a network video recorder disposed within at least a portion of the interior of the system container to retrieve video data from the at least one security camera.

### BACKGROUND

### 1. Field

The present general inventive concept relates generally to a security system, and particularly, to an enclosed security system.

### 2. Description of the Related Art

Security systems are an important line of defense for a property owner. Typically, security systems provide surveillance of property using video, audio, motion detection, and/or thermal sensors.

Moreover, traditional methods of using alarm systems or camera system usually requires heavy wiring and construction. Choosing a combination of systems for optimum protection can be difficult as most accessories like security cameras are bulky and obvious. Also, having too many exposed wires can reduce the effectiveness because a keen observer may easily see the exposed wiring and avoid the security system entirely or disable them.

Therefore, there is a need for an enclosed security system that obscures wiring and other important components to prevent tampering.

### SUMMARY

The present general inventive concept provides an enclosed security system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an enclosed security system, including a system container to store at least one item therein, a connection panel removably disposed within at least a portion of an interior of the system container to receive a connection from at least one security camera, and a network video recorder disposed within at least a portion of the interior of the system container to retrieve video data from the at least one security camera.

The network video recorder may be remotely controlled by an external computing device.

The enclosed security system may further include a plurality of external storage units to store the video data received from the network video recorder.

The enclosed security system may further include a signal scrambling unit disposed within at least a portion of the interior of the system container to prevent at least one of unauthorized access and attempted theft of the video data from an external signal reader.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front perspective view of an enclosed security system with a system container in an opened position, according to an exemplary embodiment of the present general inventive concept;

FIG. 1B illustrates a front perspective view of the enclosed security system with the system container in a closed position, according to an exemplary embodiment of the present general inventive concept;

FIG. 2A illustrates a front perspective view of a connection panel, according to an exemplary embodiment of the present general inventive concept;

FIG. 2B illustrates a front perspective view of a connection panel, according to another exemplary embodiment of the present general inventive concept;

FIG. 2C illustrates a front perspective view of a connection panel, according to another exemplary embodiment of the present general inventive concept; and

FIG. 2D illustrates a front perspective view of a connection panel, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Enclosed Security System 100

System Container 110

Door 111

Fan 111a

Lock 111b

First Indicator 111c

Second Indictor 111d

Connection Panel 120

Panel Body 121

Network Connection Port 122

Camera Connection Ports 123

HDMI Connection Port 124

USB Connection Port 125

VGA Connection Port 126

Network Video Recorder 130

Input Unit 131

Processing Unit 132

Communication Unit 133

Storage Unit 134

External Storage Units 140

Power Controller 150

Power Source 160

Power Inlet 161

Battery 162

Battery Backup Unit 163

Power Inlet Splitter 170

Wiring Aperture 180

Signal Scrambling Unit 190

Connection Panel 220

Panel Body 221

Network Connection Port 222

Camera Connection Ports 223

HDMI Connection Port 224

USB Connection Port 225

VGA Connection Port 226

Connection Panel 320

Panel Body 321

Network Connection Port 322

Camera Connection Ports 323

HDMI Connection Port 324

USB Connection Port 325

VGA Connection Port 326

Connection Panel 420

Panel Body 421

Network Connection Port 422

Camera Connection Ports 423

HDMI Connection Port 424

USB Connection Port 425

VGA Connection Port 426

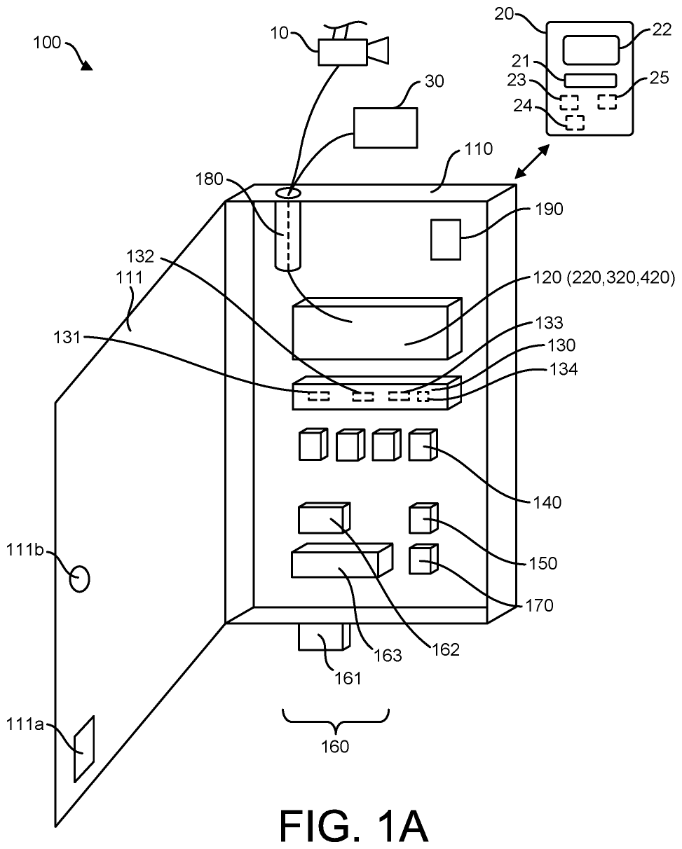

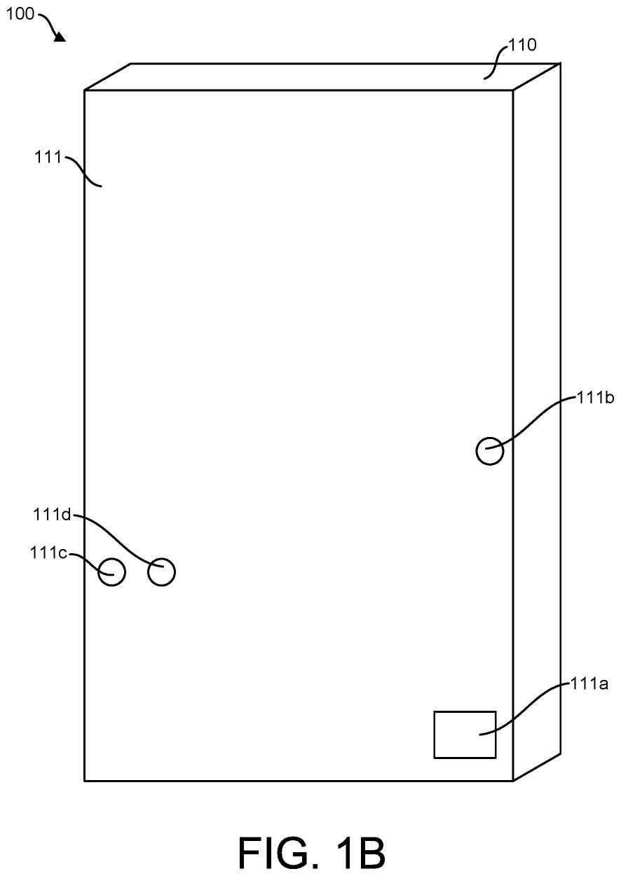

FIG. 1A illustrates a front perspective view of an enclosed security system 100 with a system container 110 in an opened position, according to an exemplary embodiment of the present general inventive concept.

FIG. 1B illustrates a front perspective view of the enclosed security system 100 with the system container 110 in a closed position, according to an exemplary embodiment of the present general inventive concept.

The enclosed security system 100 may be constructed from at least one of metal, plastic, wood, glass, ceramic, and rubber, etc., but is not limited thereto.

The enclosed security system 100 may include the system container 110, a connection panel 120, a network video recorder 130, a plurality of external storage units 140, a power controller 150, a power source 160, a power inlet splitter 170, a wiring aperture 180, and a signal scrambling unit 190, but is not limited thereto.

Referring to FIGS. 1A and 1B, the system container 110 is illustrated to have a rectangular prism shape. However, the system container 110 may be rectangular, circular, pentagonal, hexagonal, octagonal, or any other shape known to one of ordinary skill in the art, but is not limited thereto.

The system container 110 may store at least one item therein, such as system components.

The system container 110 may include a door 111, but is not limited thereto.

The door 111 may include a fan 111a, a lock 111b, a first indicator 111c, and a second indicator 111d, but is not limited thereto.

The door 111 may be hingedly disposed on at least a portion of a side of the system container 110 to pivot from a first position (i.e. closed) to at least partially toward a second position (i.e. opened). Alternatively, the door 111 may be magnetically disposed on at least a portion of a side of the system container 110. As such, the door 111 may be removed from the side of the system container 110, and subsequently reconnected thereto.

The fan 111a may be disposed on at least a portion of the door 111. The fan 111a may facilitate the flow of air in and/or out of the system container 110, such that an interior portion may cool in response to rotation of the fan 111a.

The lock 111b may include a biometric reader, a voice recognition unit, a keypad, a dial, a keylock, and a padlock, but is not limited thereto.

The lock 111b may be disposed on at least a portion of the door 111 to prevent unauthorized access to the interior of the system container 110.

The first indicator 111c may include a light and/or an audio unit, but is not limited thereto.

The second indicator 111d may include a light and/or an audio unit, but is not limited thereto.

The connection panel 120 may be removably disposed within at least a portion of the interior of the system container 110. The connection panel 120 may be exchanged based on a preference of a user.

The network video recorder (NVR) 130 may include an input unit 131, a processing unit 132, a communication unit 133, and a storage unit 134, but is not limited thereto.

The input unit 131 may include a keyboard, a touchpad, a mouse, a trackball, a stylus, a voice recognition unit, a visual data reader, a camera, a wireless device reader, and a holographic input unit.

The processing unit 132 (or central processing unit, CPU) may include electronic circuitry to carry out instructions of a computer program by performing basic arithmetic, logical, control and input/output (I/O) operations specified by the instructions. The processing unit 132 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 132 may also include a microprocessor and a microcontroller.

The communication unit 133 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 134 may include a random access memory (RAM), a read-only memory (ROM), a hard disk, a flash drive, a database connected to the Internet, cloud-based storage, Internet-based storage, or any other type of storage unit.

Each of the plurality of external storage units 140 may include a random access memory (RAM), a read-only memory (ROM), a hard disk, a flash drive, a database connected to the Internet, cloud-based storage, Internet-based storage, or any other type of storage unit.

Moreover, the plurality of external storage units 140 may be configured as a redundant array of independent disks (RAID) to store video data from at least one security camera 10 thereupon. As such, the plurality of external storage units 140 may be used to store different video data on each of the plurality of external storage units 140 and/or store redundant video data in the event of hardware failure.

The processing unit 132 may access the Internet via the communication unit 133 to allow the user to access a website and/or the software application to be executed using the processing unit 132. For ease of description, the software application will be hereinafter referred to as an app. The app may be downloaded from the Internet to be stored on the storage unit 134.

The processing unit 132 may use the app to control information received from the at least one security camera 10. Specifically, the processing unit 132 may retrieve operation commands from the storage unit 134 to control the video data stored on the plurality of external storage units 140. The input unit 131 may receive a command from the user to control the processing unit 132 to retrieve the video data from the plurality of external storage units 140 to be displayed on an external display unit 30. As such, the user may review the video data for security vulnerabilities, such as the at least one security camera 10 malfunctioning.

Furthermore, the NVR 130 may be remotely controlled by an external computing device 20.

The external computing device 20 may include an input unit 21, display unit 22, a processing unit 23, a communication unit 24, and a storage unit 25.

The input unit 21 may include a keyboard, a touchpad, a mouse, a trackball, a stylus, a voice recognition unit, a visual data reader, a camera, a wireless device reader, and a holographic input unit.

The display unit 22 may include a plasma screen, an LCD screen, a light emitting diode (LED) screen, an organic LED (OLED) screen, a computer monitor, a hologram output unit, a sound outputting unit, or any other type of device that visually or aurally displays data.

Also, the display unit 22 may be combined with the input unit 21 to be a touch-screen.

The processing unit 23 (or central processing unit, CPU) may include electronic circuitry to carry out instructions of a computer program by performing basic arithmetic, logical, control and input/output (I/O) operations specified by the instructions. The processing unit 23 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit 23 may also include a microprocessor and a microcontroller.

The communication unit 24 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 25 may include a random access memory (RAM), a read-only memory (ROM), a hard disk, a flash drive, a database connected to the Internet, cloud-based storage, Internet-based storage, or any other type of storage unit.

For ease of description, the external computing device 20 will be hereinafter interpreted to be a smart phone with a touch-screen.

The external computing device 20 may access the Internet via the communication unit 24 to allow the user to access a website, and/or may allow a program and/or an application to be executed using the processing unit 23. The program and/or the application may be downloaded from the Internet to be stored on the storage unit 25. The program and/or the application may be similar to the app as described above.

The external computing device 20 may communicate with the NVR 130 using the communication unit 24 to communicate with the communication unit 133 of the NVR 130. Additionally, the external computing device 20 may perform all functions remotely, as described above with respect to the NVR 130. However, the computing device 20 may review the video data via the display unit 22.

The power controller 150 may be disposed within at least a portion of the interior of the system container 110. The power controller 150 may be used to turn on and/or turn off at least one of the connection panel 120, the NVR 130, and the plurality of external storage units 140.

Furthermore, the power controller 150 and/or the external computing device 20 may be used to troubleshoot, alter, or restart the enclosed security system 100 remotely.

The power source 160 may include a power inlet 161, a battery 162, and a battery backup unit 163, but is not limited thereto.

The battery 162 may include lithium-ion, nickel cadmium, nickel metal hydride, alkaline, etc., but is not limited thereto.

The power inlet 161 may be disposed within at least a portion of the system container 110. The power inlet 161 may have any type of voltage. For example, the power inlet 161 may receive 120 volts to power the enclosed security system 100.

The battery 162 may be disposed within at least a portion of the system container 110. The battery 162 may supply power to the enclosed security system 100 in the event of power failure, such that the power inlet 161 does not receive external power.

The battery backup unit 163 may adjust power supplied to the enclosed security system 100 to the battery 162 in response to a power failure. Conversely, the battery backup unit 163 may adjust power supplied to the enclosed security system 100 in response to the power inlet 161 receiving external power. Moreover, the battery backup unit 163 may charge the battery 162 in response to receiving external power.

The power source 160 may provide power to the fan 111a, the lock 111b, the first indicator 111c, the second indicator 111d, the connection panel 120, the NVR 130, the plurality of external storage units 140, the power controller 150, and the signal scrambling unit 190, but is not limited thereto.

The first indicator 111c may alert the user that the enclosed security system 100 is receiving power from the power inlet 161 via a visual and/or audio alert. For example, the first indicator 111c may illuminate red to alert the user that the enclosed security system 100 is receiving power from the power inlet 161.

The second indicator 111d may alert a user that the enclosed security system 100 is receiving power from the battery 162 via a visual and/or audio alert. For example, the second indicator 111d may illuminate green to alert the user that the enclosed security system 100 is receiving power from the battery 162.

The power inlet splitter 170 may include a plurality of resistors to divide power received from the power inlet 161. Additionally, the power inlet splitter 170 may divide the power to distribute power evenly to the fan 111a, the lock 111b, the first indicator 111c, the second indicator 111d, the connection panel 120, the NVR 130, the plurality of external storage units 140, the power controller 150, and the signal scrambling unit 190.

The wiring aperture 180 may be disposed on and/or within at least a portion of the system container 110 to receive external wiring therethrough. For example, the wiring aperture 180 may receive wiring from the at least one security camera 10 and/or the external display unit 30.

The signal scrambling unit 190 may be disposed within at least a portion of the interior of the system container 110. The signal scrambling unit 190 may include a cell phone signal jammer, GSM, GPS and Wi-Fi blocker, and multiple jamming frequency bands. As such, the signal scrambling unit 190 may prevent unauthorized access and/or attempted theft of the video data from an external signal reader.

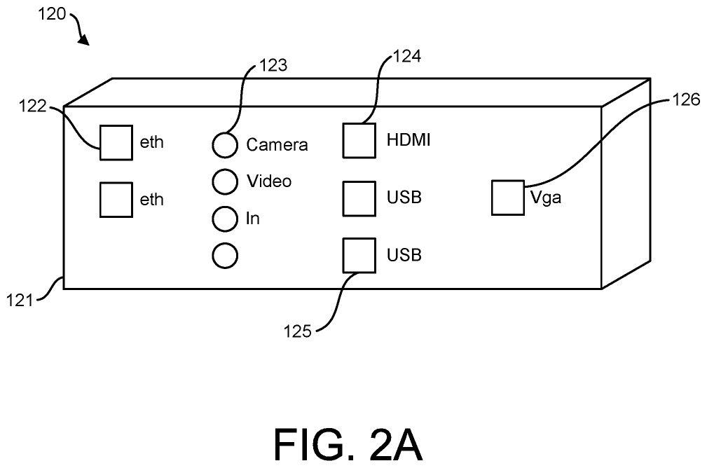

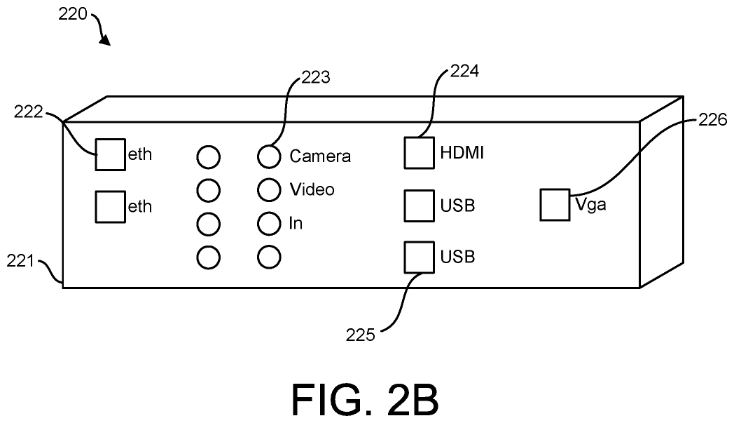

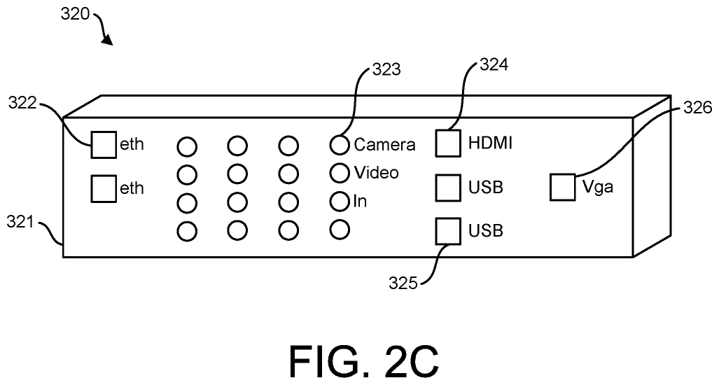

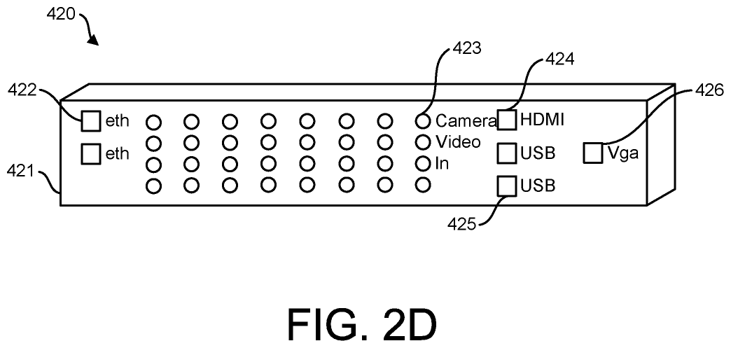

FIG. 2A illustrates a front perspective view of a connection panel 120, according to an exemplary embodiment of the present general inventive concept.

The connection panel 120 may include a panel body 121, at least one network connection port 122, a plurality of camera connection ports 123, at least one high definition multimedia interface (HDMI) connection port 124, at least one universal serial bus (USB) connection port 125, and at least one video graphics array (VGA) connection port 126, but is not limited thereto.

The panel body 121 may be constructed to have any size and have a different amount of ports based on the preference of the user.

The at least one network connection port 122 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The plurality of camera connection ports 123 may have different number of ports to receive a connection from the at least one security camera 10. For example, the plurality of camera connection ports 123 may include up to four camera connection ports 123.

The at least one HDMI connection port 124 may be connected to the external display unit 30, such that HDMI connection port 124 may transmit at least one first display signal to the external display unit 30 based on information received from the at least one security camera 10.

The at least one USB connection port 125 may be connected to the external display unit 30, such that USB connection port 125 may transmit at least one second display signal to the external display unit 30 based on information received from the at least one security camera 10.

The at least one VGA connection port 126 may be connected to the external display unit 30, such that VGA connection port 126 may transmit at least one third display signal to the external display unit 30 based on information received from the at least one security camera 10.

FIG. 2B illustrates a front perspective view of a connection panel 220, according to another exemplary embodiment of the present general inventive concept.

The connection panel 220 may include a panel body 221, at least one network connection port 222, a plurality of camera connection ports 223, at least one high definition multimedia interface (HDMI) connection port 224, at least one universal serial bus (USB) connection port 225, and at least one video graphics array (VGA) connection port 226, but is not limited thereto.

The panel body 221 may be constructed to have any size and have a different amount of ports based on the preference of the user.

The at least one network connection port 222 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The plurality of camera connection ports 223 may have different number of ports to receive a connection from the at least one security camera 10. For example, the plurality of camera connection ports 223 may include up to eight camera connection ports 223.

The at least one HDMI connection port 224 may be connected to the external display unit 30, such that HDMI connection port 224 may transmit at least one first display signal to the external display unit 30 based on information received from the at least one security camera 10.

The at least one USB connection port 225 may be connected to the external display unit 30, such that USB connection port 225 may transmit at least one second display signal to the external display unit 30 based on information received from the at least one security camera 10.

The at least one VGA connection port 226 may be connected to the external display unit 30, such that VGA connection port 226 may transmit at least one third display signal to the external display unit 30 based on information received from the at least one security camera 10.

FIG. 2C illustrates a front perspective view of a connection panel 320, according to another exemplary embodiment of the present general inventive concept.

The connection panel 320 may include a panel body 321, at least one network connection port 322, a plurality of camera connection ports 323, at least one high definition multimedia interface (HDMI) connection port 324, at least one universal serial bus (USB) connection port 325, and at least one video graphics array (VGA) connection port 326, but is not limited thereto.

The panel body 321 may be constructed to have any size and have a different amount of ports based on the preference of the user.

The at least one network connection port 322 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The plurality of camera connection ports 323 may have different number of ports to receive a connection from the at least one security camera 10. For example, the plurality of camera connection ports 323 may include up to sixteen camera connection ports 323.

The at least one HDMI connection port 324 may be connected to the external display unit 30, such that HDMI connection port 324 may transmit at least one first display signal to the external display unit 30 based on information received from the at least one security camera 10.

The at least one USB connection port 325 may be connected to the external display unit 30, such that USB connection port 325 may transmit at least one second display signal to the external display unit 30 based on information received from the at least one security camera 10.

The at least one VGA connection port 326 may be connected to the external display unit 30, such that VGA connection port 326 may transmit at least one third display signal to the external display unit 30 based on information received from the at least one security camera 10.

FIG. 2D illustrates a front perspective view of a connection panel 420, according to another exemplary embodiment of the present general inventive concept.

The connection panel 420 may include a panel body 421, at least one network connection port 422, a plurality of camera connection ports 423, at least one high definition multimedia interface (HDMI) connection port 424, at least one universal serial bus (USB) connection port 425, and at least one video graphics array (VGA) connection port 426, but is not limited thereto.

The panel body 421 may be constructed to have any size and have a different amount of ports based on the preference of the user.

The at least one network connection port 422 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The plurality of camera connection ports 423 may have different number of ports to receive a connection from the at least one security camera 10. For example, the plurality of camera connection ports 423 may include up to thirty-two camera connection ports 423.

The at least one HDMI connection port 424 may be connected to the external display unit 30, such that HDMI connection port 424 may transmit at least one first display signal to the external display unit 30 based on information received from the at least one security camera 10.

The at least one USB connection port 425 may be connected to the external display unit 30, such that USB connection port 425 may transmit at least one second display signal to the external display unit 30 based on information received from the at least one security camera 10.

The at least one VGA connection port 426 may be connected to the external display unit 30, such that VGA connection port 426 may transmit at least one third display signal to the external display unit 30 based on information received from the at least one security camera 10.

Therefore, the enclosed security system 100 may be mounted to on and/or within a wall and/or in a closet to obscure the components from view, as well as, prevent unauthorized access thereto. Also, the enclosed security system 100 may be configured with various connection panels based on the preference of the user. Moreover, the multi-channel camera system may provide multiple views of different perspectives for increased surveillance.

The present general inventive concept may include an enclosed security system 100, including a system container 110 to store at least one item therein, a connection panel 120 removably disposed within at least a portion of an interior of the system container 110 to receive a connection from at least one security camera 10, and a network video recorder 130 disposed within at least a portion of the interior of the system container 110 to retrieve video data from the at least one security camera 10.

The network video recorder 130 may be remotely controlled by an external computing device 20.

The enclosed security system 100 may further include a plurality of external storage units 140 to store the video data received from the network video recorder 130.

The enclosed security system 100 may further include a signal scrambling unit 190 disposed within at least a portion of the interior of the system container 110 to prevent at least one of unauthorized access and attempted theft of the video data from an external signal reader.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An enclosed security system, comprising:
a system container to store at least one item therein;
a connection panel removably disposed within at least a portion of an interior of the system container to receive a connection from at least one security camera;
a network video recorder disposed within at least a portion of the interior of the system container to retrieve video data from the at least one security camera; and
a power inlet splitter disposed within at least a portion of the interior of the system container to distribute power evenly between the connection panel and the network video recorder.

2. The enclosed security system of claim 1, wherein the network video recorder is remotely controlled by an external computing device.

3. The enclosed security system of claim 1, further comprising:
a plurality of external storage units to store the video data received from the network video recorder.

4. The enclosed security system of claim 1, further comprising:
a signal scrambling unit disposed within at least a portion of the interior of the system container to prevent at least one of unauthorized access and attempted theft of the video data from an external signal reader.
